(19) United States
(12) Patent Application Publication
(10) Pub. No.: US 2013/0271423 A1
(43) Pub. Date: Oct. 17, 2013

(54) INPUT DEVICE AND CONTROL PARAMETER ADJUSTING METHOD THEREOF

(71) Applicants: Ming-Chuan Lin, Taichung City (TW); Wen-Hung Wang, Taichung City (TW); Chih-Chiang Lin, Taichung City (TW)

(72) Inventors: Ming-Chuan Lin, Taichung City (TW); Wen-Hung Wang, Taichung City (TW); Chih-Chiang Lin, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/861,402

(22) Filed: Apr. 12, 2013

(30) Foreign Application Priority Data
Apr. 13, 2012 (TW) 101113273

(51) Int. Cl. G06F 3/044

(52) U.S. Cl. CPC G06F 3/044
USPC 345/174

(57) ABSTRACT

An input device and a control parameter adjusting method thereof are provided. The input device includes a first storage unit, a second storage unit and a control unit. The first storage unit is configured to store a plurality of control parameters, wherein each of the control parameters indicates a judgment standard of an input action of the input device. The second storage unit is configured to store firmware. The control unit coupled to the first storage unit and the second storage unit is configured to select a best control parameter from the control parameters according to an input control signal and program the best control parameter into the firmware. Wherein the input control signal is generated corresponding to the input action of the input device.

### CROSS-REFERENCE TO RELATED APPLICATION

This application claims the priority benefit of Taiwan application serial no. 101113273, filed on Apr. 13, 2012. The entirety of the above-mentioned patent application is hereby incorporated by reference herein and made a part of this specification.

### BACKGROUND OF THE INVENTION

1. Field of the Invention

The invention relates to an input device. Particularly, the invention relates to an input device capable of flexibly adjusting control parameters and a control parameter adjusting method thereof.

2. Description of Related Art

Along with development of technology, conventional display panels have been gradually replaced by touch panels. Generally, regarding the touch panels of different lots, sensitivities in touch detection thereof are different. Conventionally, to ensure the manufactured touch panels to have the same sensitivity, the touch panel with lower sensitivity is assigned with a lower judgment standard value in an algorithm of determining whether the touch panel is touched, so as to avoid a situation of unable to detect a touch signal. The touch panel with higher sensitivity is assigned with a higher judgment standard value in the algorithm of determining whether the touch panel is touched, so as to avoid a miss operation due to over-sensitive.

In order to resolve the aforementioned problem, a conventional method is to set a suitable judgment standard value for the touch panels of each different lot, and program the judgment standard value into firmware of the touch panels, though such method greatly decreases productivity of the touch panels.

### SUMMARY OF THE INVENTION

The invention is directed to an input device and a control parameter adjusting method thereof, which greatly increase productivity of the input device.

The invention provides an input device and a control parameter adjusting method thereof. The input device includes a first storage unit, a second storage unit and a control unit. The first storage unit is configured to store a plurality of control parameters, where each of the control parameters indicates a judgment standard of an input action of the input device. The second storage unit is configured to store firmware. The control unit is coupled to the first storage unit and the second storage unit, and is configured to select a best control parameter from the control parameters according to an input control signal and program the best control parameter into the firmware. The input control signal is generated corresponding to the input action of the input device.

The invention provides an input device and a control parameter adjusting method thereof, where the input device includes a storage unit configured to store firmware, and each control parameter indicates a judgment standard of an input action of the input device. The control parameter adjusting method of the input device includes following steps. A best control parameter is selected from a plurality of the control parameters according to an input control signal, where the input control signal is generated corresponding to the input action of the input device, and the best control parameter is programmed into the firmware.

According to the above descriptions, the input device and the control parameter adjusting method thereof can select a best control parameter from a plurality of the control parameters, so as to ameliorate a problem that a firmware version has to be modified according to a process difference, which may greatly improve productivity of the input device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an input device according to an embodiment of the invention.

FIG. 2 is a functional block diagram of an input device according to another embodiment of the invention.

FIG. 3A and FIG. 3B are comparison diagrams of an input control signal ICS and a first control parameter FCP and a second control parameter SCP.

FIG. 4 is a functional block diagram of an input device according to another embodiment of the invention.

FIG. 5 is a functional block diagram of an input device according to still another embodiment of the invention.

FIG. 6 is a flowchart illustrating a control parameter adjusting method according to an embodiment of the invention.

FIG. 7 is a flowchart illustrating a control parameter adjusting method according to an embodiment of the invention.

FIG. 8 is a flowchart illustrating a control parameter adjusting method according to another embodiment of the invention.

FIG. 9 is a flowchart illustrating a control parameter adjusting method according to another embodiment of the invention.

### DETAILED DESCRIPTION OF DISCLOSED EMBODIMENTS

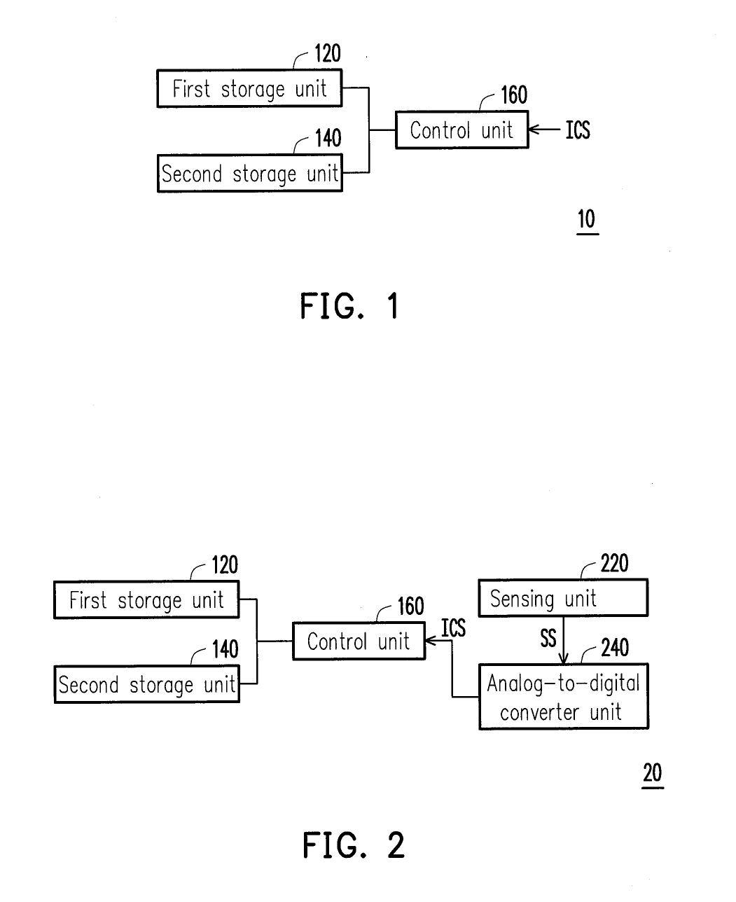

FIG. 1 is a functional block diagram of an input device according to an embodiment of the invention.

Referring to FIG. 1, the input device 10 includes a first storage unit 120, a second storage unit 140 and a control unit 160. In the present embodiment, the input device 10 can be a touch device such as a handheld touch panel or a desktop touch panel, etc.

The first storage unit 120 is used to storage a plurality of control parameters, where each of the control parameters is, for example, a judgment standard value configured to indicate a judgment standard of an input action of the input device 10. For example, it is assumed that the input device 10 is a touch panel, and regarding different types of touch panels, the control parameter can be a voltage threshold value of a capacitive touch panel, a pressure threshold value of a resistive touch panel, or a light-sensitive threshold value of an optical touch panel. Moreover, for simplicity's sake, a first control parameter and a second control parameter stored in the first storage unit 120 are taken as an example for descriptions, where a value of the first control parameter is greater than a value of the second control parameter. It should be noticed that the first control parameter and the second control parameter are only used to distinguish a plurality of control parameters with different values, and are not used to limit the invention.

The second storage unit 140 is configured to store data in form of firmware. In the present embodiment, the data in form of firmware can be a driving program or an algorithm module, for example, an algorithm module used in the control unit 160 for detecting whether a user's finger jitters or slides on the touch panel.

In the present embodiment, the first storage unit 120 and the second storage unit 140 can be magnetic storage media or non-volatile memory module, which is not limited by the invention.

The control unit 160 is coupled to the first storage unit 120 and the second storage unit 140, and is configured to select a best control parameter from the control parameters stored in the first storage unit 120 according to an input control signal ICS. The control unit 160 is, for example, implemented by an application program processor or a microcontroller. Moreover, the input control signal ICS is generated corresponding to the input action of the input device 10 (for example, the capacitive touch panel generates a corresponding voltage value in response to a touch operation of the user). It should be noticed that in the present embodiment, the input device 10 may further include integrated circuit devices such as a driving circuit, a single chip or a chip set, etc. When the user performs the input action on the input device 10, the control unit 160 obtains the input control signal ICS generated by the input action through the aforementioned integrated circuits.

FIG. 2 is a functional block diagram of an input device according to another embodiment of the invention. In detail, a method for generating the input control signal ICS is as that shown in FIG. 2. Referring to FIG. 2, a difference between the input device 20 of the present embodiment and the input device 10 of the embodiment of FIG. 1 is that the input device 20 further includes a sensing unit 220 and an analog-to-digital converter (ADC) unit 240.

The sensing unit 220 is used to detect a sensing signal SS output by the input device 20 (for example, a capacitive touch panel), where the sensing signal SS is generated corresponding to a touch operation performed on the touch panel, for example, a capacitance variation signal generated by touching the capacitive touch panel. Moreover, the ADC unit 240 is coupled to the control unit 160, which is used to convert the sensing signal SS (an analog signal) into the input control signal ICS (a digital signal, for example, a digital data stream). Generally, the control unit 160 (for example, a microcontroller) can only process the digital data stream.

It should be noticed that although the capacitive touch panel of the present embodiment is taken as an example for descriptions, the invention is not limited thereto, and the input device 20 can also be a resistive touch panel or an optical touch panel.

Referring to FIG. 1 again, in detail, the control unit 160 is used to compare the input control signal ICS with the first control parameter and the second control parameter, where when a value of the input control signal ICS is greater than the first control parameter, the control unit 160 selects the first control parameter as the best control parameter, and when the value of the input control signal ICS is smaller than or equal to the first control parameter, the control unit 160 selects the second control parameter as the best control parameter.

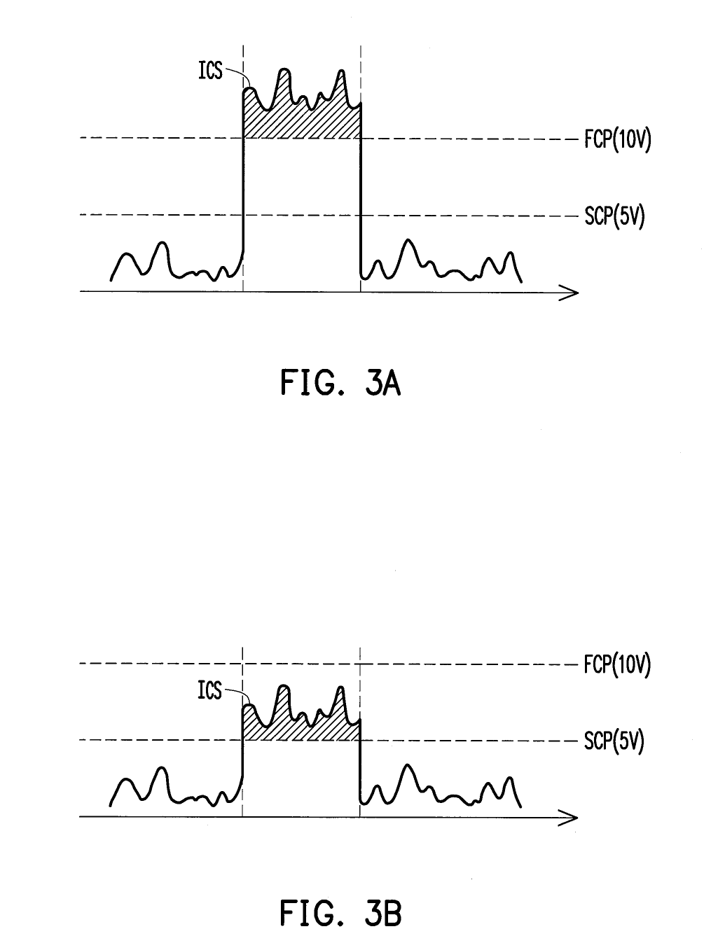

Taking the capacitive touch panel as an example, referring to FIG. 1 and sequentially referring to FIG. 3A and FIG. 3B, where FIG. 3A and FIG. 3B are comparison diagrams of the input control signal ICS and the first control parameter FCP and the second control parameter SCP. For simplicity's sake, in FIG. 3A and FIG. 3B, the first control parameter FCP is, for example, 10V (i.e. the judgment standard value is 10V), and the second control parameter SCP is, for example, 5V (i.e. the judgment standard value is 5V). In FIG. 3A, a minimum ripple voltage level of the input control signal ICS is, for example, 13V. The control unit 160 first compares the voltage level 13V of the input control signal ICS with the first control parameter FCP (with a value of 10V). Now, since the minimum ripple voltage level 13V of the input control signal ICS is greater than the first control parameter FCP (the first control parameter FCP (10V) of FIG. 3A), the control unit 160 selects the first control parameter FCP as the best control parameter. In FIG. 3B, the voltage level of the input control signal ICS is, for example, between 10V and 5V, and now the voltage level of the input control signal ICS is smaller than the first control parameter FCP (with a value of 10V), and is greater than the second control parameter SCP (with a value of 5V) (the second control parameter SCP (5V) of FIG. 3B), the control unit 160 selects the second control parameter SCP as the best control parameter.

Referring to FIG. 1 again, in the present embodiment, the control unit 160 can further program the best control parameter into the firmware (or an algorithm module) stored in the second storage unit 140. In detail, after the control unit 160 programs the best control parameter into the second storage unit 140, the firmware (or the algorithm module) in the second storage unit 140 can use such best control parameter, and the best control parameter can be taken as a basis for determining whether the input control signal ICS is a valid enable signal. For example, when the value of the input control signal ICS is greater than the best control parameter, the control unit 160 determines that the input device 10 is in a user touch state, and obtains coordinates of the user touch operation on the input device 10 by using the predetermined algorithm module and the input control signal ICS.

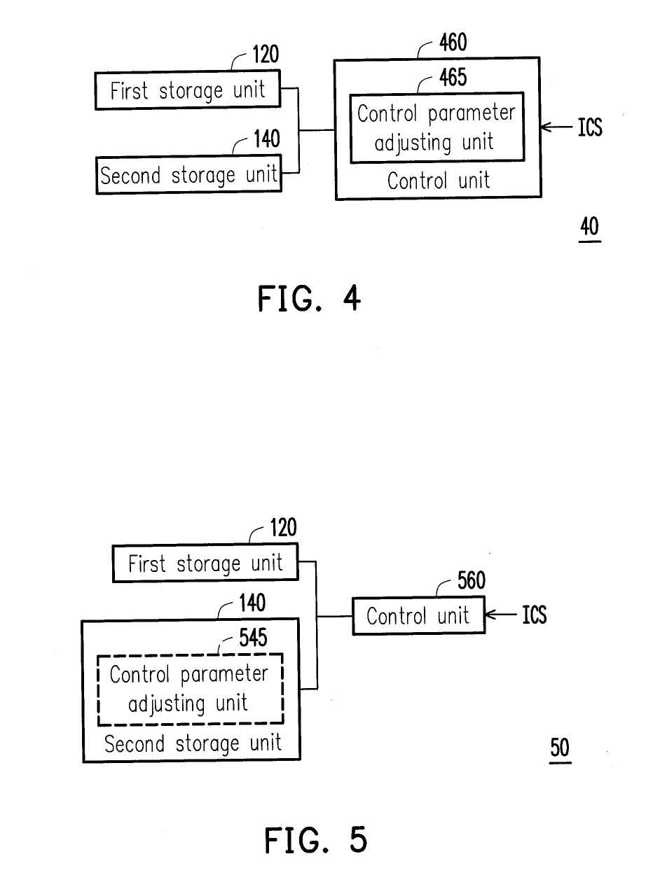

FIG. 4 is a functional block diagram of the input device according to another embodiment of the invention.

Referring to FIG. 4, the input device 40 includes a first storage unit 120, the second storage unit 140, a control unit 460 and a control parameter adjusting unit 465. It should be noticed that the first storage unit 120 and the second storage unit 140 are respectively similar to the first storage unit 120 and the second storage unit 140 of FIG. 1, so that detailed descriptions thereof are not repeated, and only the control unit 460 and the control parameter adjusting unit 465 are described.

The control parameter adjusting unit 465 is used to compare the input control signal ICS with the first control parameter and the second control parameter, and adjust the best control parameter according to a comparison result thereof, where when the input control signal ICS is greater than the first control parameter, the control parameter adjusting unit 465 adjusts the best control parameter to the first control parameter, and when the input control signal ICS is smaller than or equal to the first control parameter, the control parameter adjusting unit 465 adjusts the best control parameter to the second control parameter, and transmits the best control parameter to the control unit 460. In an embodiment of the invention, the control parameter adjusting unit 465 is, for example, implemented by a comparator.

Moreover, the control unit 460 is coupled to the control parameter adjusting unit 465, which is used to select the adjusted best control parameter through the control parameter adjusting unit 465, and program the best control parameter.

It should be noticed that as shown in FIG. 4, in the present embodiment, the control parameter adjusting unit 465 is a hardware device configured in the control unit 460, though the invention is not limited thereto.

For example, FIG. 5 is a functional block diagram of an input device according to still another embodiment of the invention.

Referring to FIG. 5, in the present embodiment, a control parameter adjusting unit 545 can also be stored in the second storage unit 140 in form of firmware. The input device 50 includes the first storage unit 120, the second storage unit 140, a control unit 560 and the control parameter adjusting unit 545. It should be noticed that the first storage unit 120 and the second storage unit 140 are respectively similar to the first storage unit 120 and the second storage unit 140 of FIG. 1, so that details thereof are not repeated.

In detail, a difference between the present embodiment and FIG. 4 is that the control unit 560 of the present embodiment can directly select the adjusted best control parameter through the control parameter adjusting unit 545 stored in the second storage unit 140 in form of firmware without adding an extra hardware device (i.e. the control parameter adjusting unit 465) in the control unit 460 as that shown in FIG. 4. Moreover, a method for the control parameter adjusting unit 545 adjusting the best control parameter is similar to that of the control parameter adjusting unit 465 of FIG. 4, which is not repeated.

It should be noticed that although the touch panel is used in the aforementioned embodiments for descriptions, the invention is not limited thereto, and the input device 20 can also be other electronic products with control parameters required to be adjusted, such as a mouse, a keyboard and a joy stick, etc.

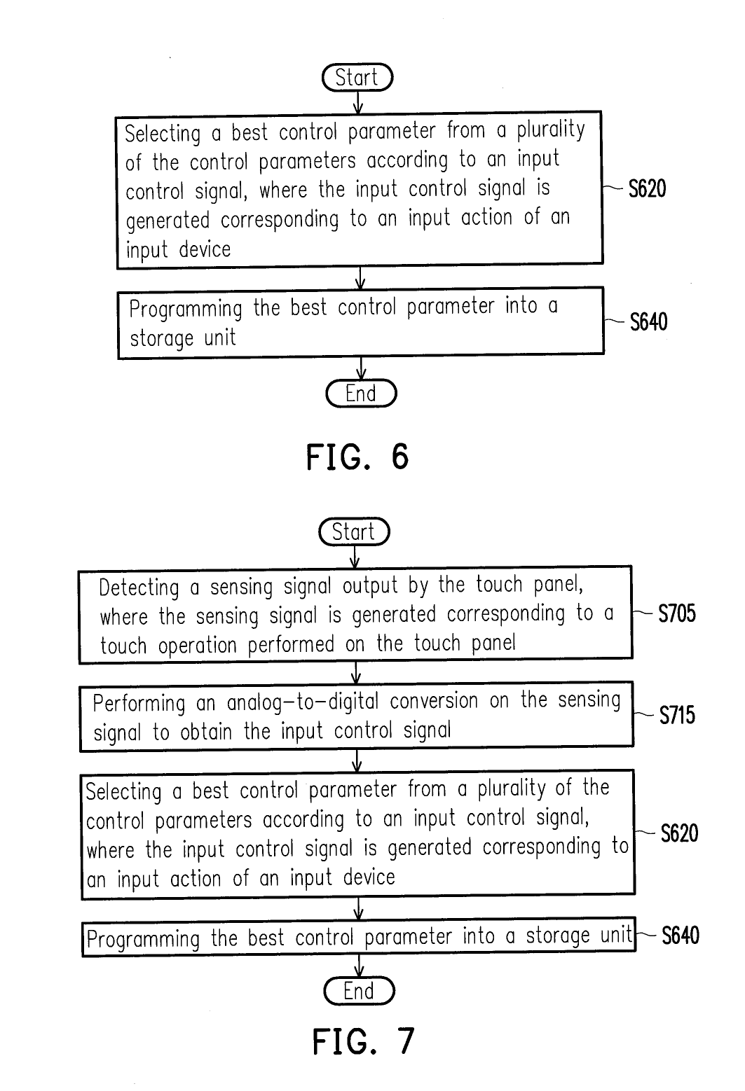

FIG. 6 is a flowchart illustrating a control parameter adjusting method according to an embodiment of the invention. The control parameter adjusting method of the aforementioned input device may include steps shown in FIG. 6.

Referring to FIG. 1 and FIG. 6, in step S620, the control unit 160 selects the best control parameter from a plurality of the control parameters according to the input control signal ICS, where the input control signal ICS is generated corresponding to the input action of the input device. It should be noticed that in an embodiment of the invention, the control unit can also execute the selection through a control parameter adjusting unit, where the control parameter adjusting unit can be implemented by firmware or hardware.

In step S640, the control unit 160 programs the best control parameter into the storage unit, for example, the control unit 160 programs the best control parameter into the firmware stored in the storage unit, and takes the best control parameter as a basis for determining whether the input control signal ICS is a valid enable signal.

Referring to FIG. 2 and FIG. 7, FIG. 7 is a flowchart illustrating a control parameter adjusting method in case that the input device is a touch panel according to an embodiment of the invention. A difference between the control parameter adjusting method of the present embodiment and the control parameter adjusting method of FIG. 6 is that the control parameter adjusting method of the present embodiment further includes a step S705 and a step S715.

In the step S705, the sensing unit 220 detects the sensing signal SS output by the touch panel, where the sensing signal SS is generated corresponding to a touch operation performed on the touch panel.

In step S715, the ADC unit 240 performs an analog-to-digital conversion on the sensing signal SS to obtain the input control signal ICS, where the input control signal ICS obtained after the analog-to-digital conversion is a digital signal.

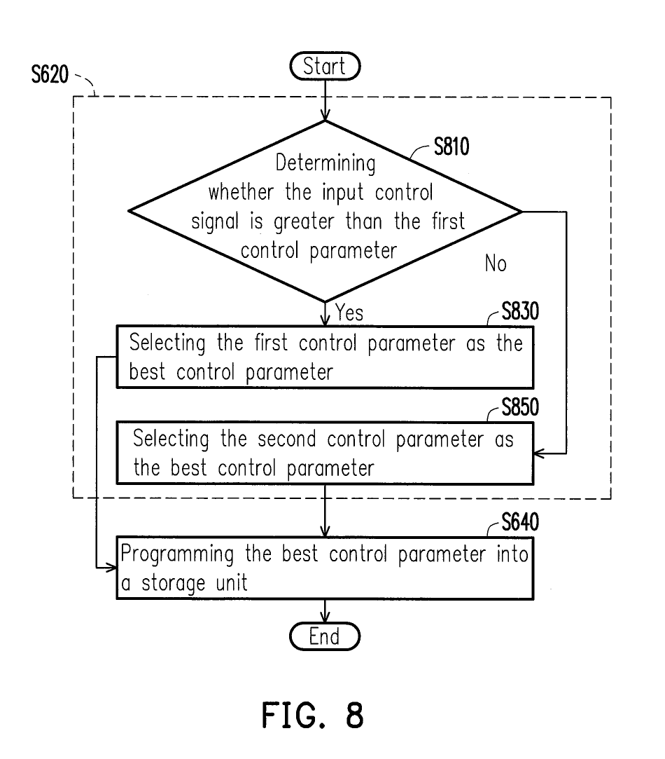

In detail, regarding the step S620 of FIG. 6 and FIG. 7, a method of selecting the best control parameter from the control parameters according to the input control signal is as that shown in FIG. 8. FIG. 8 is a flowchart illustrating a control parameter adjusting method according to another embodiment of the invention.

Referring to FIG. 8, in step S810, it is determined whether the input control signal is greater than the first control parameter, where if the input control signal is greater than the first control parameter, a step S830 is executed after the step S810, and if the input control signal is smaller than or equal to the first control parameter, a step S850 is executed after the step S810. In the present embodiment, the control unit is used to determine whether the input control signal is greater than the first control parameter, though the invention is not limited thereto. In an embodiment of the invention, such step can also be executed by the control parameter adjusting unit.

In the step S830, the first control parameter is selected as the best control parameter.

In step S850, the second control parameter is selected as the best control parameter. It should be noticed that the step S830 and the step S850 of the present embodiment can all be executed by the control unit. However, in an embodiment of the invention, the control unit can also execute the step S830 and the step S850 through the control parameter adjusting unit.

In step S640, the best control parameter is programmed into the storage unit.

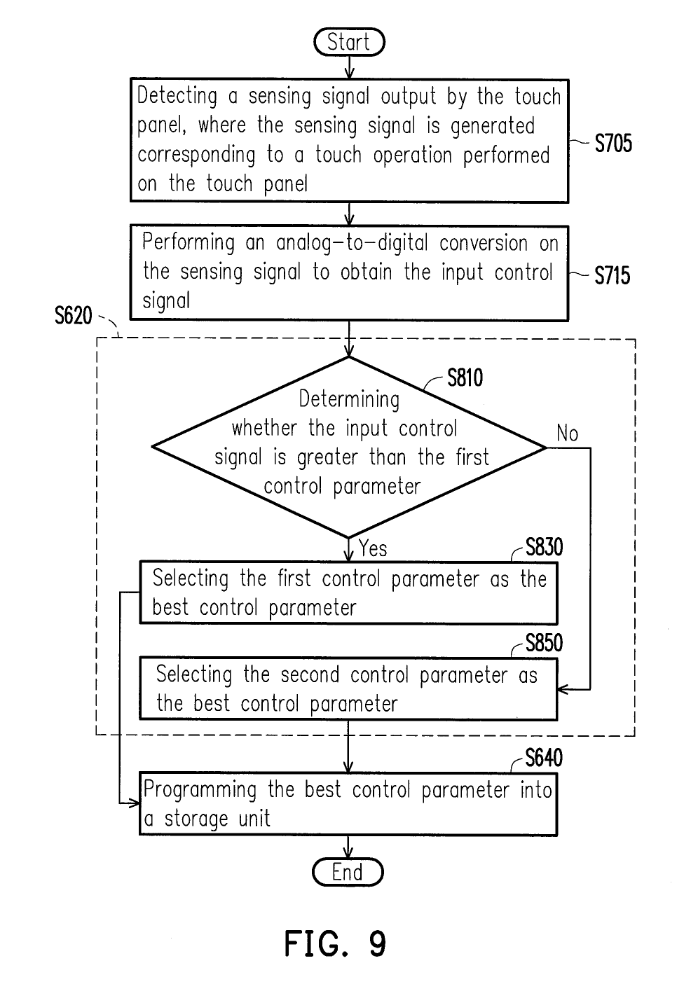

FIG. 9 is a flowchart illustrating a control parameter adjusting method in case that the input device is a touch panel according to another embodiment of the invention. As shown in FIG. 9, the control parameter adjusting method of the embodiment of FIG. 8 further includes the steps S705-S715 of the embodiment of FIG. 7, since the descriptions of the steps S705-S715 have been presented in the embodiment of FIG. 8, details thereof are not repeated.

It should be noticed that although the touch panel is used in the aforementioned embodiments for descriptions, the invention is not limited thereto, and the control parameter adjusting method of the invention can also be applied in other electronic products with control parameters required to be adjusted, such as a mouse, a keyboard and a joy stick, etc.

Since those skilled in the art can learn enough instructions and recommendations of the aforementioned method from the descriptions of the aforementioned embodiments, detailed description thereof is not repeated.

In summary, the input device and the control parameter adjusting method thereof can select a best control parameter from a plurality of the control parameters according to the input control signal, and program the best control parameter into the input device to serve as a threshold for determining the touch operation, so as to ameliorate the problem that the same touch panel requires a plurality of algorithms in collaboration with a plurality of judgment standard values.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An input device, comprising:
a first storage unit, configured to store a plurality of control parameters, wherein each of the control parameters indicates a judgment standard of an input action of the input device;
a second storage unit, configured to store firmware; and
a control unit, coupled to the first storage unit and the second storage unit, and configured to select a best control parameter from the control parameters according to an input control signal and program the best control parameter into the firmware, wherein the input control signal is generated corresponding to the input action of the input device.

2. The input device as claimed in claim 1, wherein the control parameters comprise a first control parameter and a second control parameter, and a value of the first control parameter is greater than a value of the second control parameter, the control unit compares the input control signal with the first control parameter and the second control parameter, and selects the best control parameter according to a comparison result, wherein when the input control signal is greater than the first control parameter, the control unit selects the first control parameter as the best control parameter, and when the input control signal is not greater than the first control parameter, the control unit selects the second control parameter as the best control parameter.

3. The input device as claimed in claim 1, wherein the control parameters comprise a first control parameter and a second control parameter, and a value of the first control parameter is greater than a value of the second control parameter, and the input device further comprises:
a control parameter adjusting unit, configured to compare the input control signal with the first control parameter and the second control parameter, and adjust the best control parameter according to a comparison result, and the control unit selects the adjusted best control parameter through the control parameter adjusting unit, wherein when the input control signal is greater than the first control parameter, the control parameter adjusting unit adjusts the best control parameter to the first control parameter, and when the input control signal is not greater than the first control parameter, the control parameter adjusting unit adjusts the best control parameter to the second control parameter.

4. The input device as claimed in claim 3, wherein the control parameter adjusting unit is stored in the second storage unit in form of firmware.

5. The input device as claimed in claim 3, wherein the control parameter adjusting unit is configured in the control unit in form of hardware.

6. The input device as claimed in claim 1, wherein the input device is a touch panel, and the input device further comprises:
a sensing unit, detecting a sensing signal output by the touch panel, wherein the sensing signal is generated corresponding to a touch operation performed on the touch panel; and
an analog-to-digital converter unit, coupled to the sensing unit and the control unit, and converting the sensing signal into the input control signal.

7. The input device as claimed in claim 1, wherein the control unit is an application program processor or a microcontroller.

8. A control parameter adjusting method of an input device, wherein the input device comprises a storage unit configured to store firmware, and each of plural control parameters indicates a judgment standard of an input action of the input device, the control parameter adjusting method of the input device comprising:
selecting a best control parameter from the control parameters according to an input control signal, wherein the input control signal is generated corresponding to the input action of the input device; and
programming the best control parameter into the firmware.

9. The control parameter adjusting method of the input device as claimed in claim 8, wherein the control parameters comprise a first control parameter and a second control parameter, and a value of the first control parameter is greater than a value of the second control parameter, and the step of selecting the best control parameter from the control parameters according to the input control signal comprises:
determining whether the input control signal is greater than the first control parameter;
selecting the first control parameter as the best control parameter when the input control signal is greater than the first control parameter, and
selecting the second control parameter as the best control parameter when the input control signal is not greater than the first control parameter.

10. The control parameter adjusting method of the input device as claimed in claim 8, wherein the input device is a touch panel, and the control parameter adjusting method of the input device further comprises:
detecting a sensing signal output by the touch panel, wherein the sensing signal is generated corresponding to a touch operation performed on the touch panel; and
performing an analog-to-digital conversion on the sensing signal to obtain the input control signal.
